(19) United States
(12) Patent Application Publication
(10) Pub. No.: US 2022/0278411 A1
(43) Pub. Date: Sep. 1, 2022

(54) POWER SUPPLY DEVICE, AND ELECTRIC VEHICLE AND POWER STORAGE DEVICE EQUIPPED WITH THIS POWER SUPPLY DEVICE

(71) Applicant: SANYO Electric Co., Ltd., Osaka (JP)

(72) Inventor: HIROSHI TAKATA, Hyogo (JP)

(21) Appl. No.: 17/632,039

(22) PCT Filed: Jul. 20, 2020
(86) PCT No.: PCT/JP2020/028028

§ 371 Date: Feb. 1, 2022

(30) Foreign Application Priority Data
Aug. 3, 2019 (JP) 2019-143427

(51) Int. Cl. H01M 50/264; B60K 1/04; B60L 58/10; H01M 50/209; H01M 50/249; H01M 10/42; H01M 10/44

(52) U.S. Cl. CPC H01M 50/264; B60K 1/04; B60L 58/10; H01M 50/209; H01M 50/249; H01M 10/4257; H01M 10/441; H01M 2220/20; H01M 2010/4271

(57) ABSTRACT

In power supply device, binding bar is fixed to a pair of end plates disposed at both ends of battery stack formed by stacking a plurality of battery cells in order to suppress displacement of the battery cells by reducing deformation of the battery stack. Binding bar is provided with fixing piece of bracket fixed to base plate so as to protrude from a surface of binding bar. In binding bar, an middle part of the binding bar is defined as a fixing piece region, a straight part extending in a longitudinal direction at a part of an outer peripheral edge is defined as a bending line, a region excluding the bending line is cut along a cutting line and bent along the bending line, the fixing piece region is defined as fixing piece protruding outward, and fixing piece region is defined as opening window. Bracket includes a fixing part, rising part, and base plate connector, fixing piece is fixed to the fixing part, and binding bar is fixed to base plate via bracket.

### TECHNICAL FIELD

The present invention relates to a power supply device with a plurality of prismatic battery cells stacked, and an electric vehicle and a power storage device equipped with the power supply device.

### BACKGROUND ART

A power supply device with a secondary battery has been used for a power source for driving a vehicle. In such a power supply device, a configuration is generally adopted in which end plates are arranged on both end faces of a battery stack in which a plurality of battery cells are stacked, and the end plates are fastened with right and left binding bars (see PTL 1). In such a power supply device, in order to improve output, the number of battery cells may be increased, for example.

Further, as a method of fastening such a power supply device to an electric vehicle and a power storage device, a method of providing a hole at a predetermined position of a binding bar and fastening the power supply device to the electric vehicle and the power storage device with a screw or the like has been conventionally known.

However, in the configuration using the end plates and the binding bars as described above, as the number of battery cells increases, the battery stack becomes longer and a bending moment becomes stronger, so that a corresponding rigidity increase is required. It is necessary to increase a rigidity of the binding bars such that it can withstand a bending moment with respect to a load of the battery cell. Therefore, it is necessary to take measures such as thickening a metal sheet constituting a binding bar and using a stronger material thereby causing problems such as heavy weight and high cost. Further, as the number of battery cells increases, there is a concern that displacement of a battery cell located at a center becomes larger.

### CITATION LIST

### Patent Literature

PTL 1: WO2012/131837

### SUMMARY OF THE INVENTION

### Technical Problem

The present invention has been developed for the purpose of solving the above drawbacks, and one of the objects of the present invention is to provide a technique for reducing deformation of a battery stack and suppressing displacement of a battery cell.

### Solution to Problem

A power supply device according to an aspect of the present invention includes battery stack 10 having a plurality of prismatic battery cells 1 stacked together, a pair of end plates 4, and binding bars 2. Each of the pair of end plates 4 is disposed at an end of battery stack 10 in a stacked direction of battery stack 10. Each of the binding bars 2 has its both ends coupled to the pair of end plates 4. Binding bar 2 is a metal sheet, and fixing piece 41 of bracket 71 to be fixed to base plate 70 is provided so as to protrude from a surface of binding bar 2 in an integral structure. Further, binding bar 2 defines a middle part of binding bar 2 in a longitudinal direction and a width direction as fixing piece region 40 constituting fixing piece 41, a straight part extending in the longitudinal direction along a part of the outer peripheral edge of fixing piece region 40 as bending line 42 extending in the longitudinal direction of binding bar 2, and a region excluding bending line 42 on the outer peripheral edge of fixing piece region 40 as cutting line 43. Cutting line 43 is cut, and fixing piece region 40 is bent at bending line 42 and used as fixing piece 41 protruding outward. The original position of fixing piece region 40 is defined as opening window 45. Bracket 71 includes fixing part 74 fixed to fixing piece 41, rising part 73 having fixing part 74 at the tip thereof, and base plate connector 72 provided at the lower end of rising part 73, and fixing piece 41 is fixed to fixing part 74 of bracket 71, and binding bar 2 is fixed to base plate 70 via bracket 71.

An electric vehicle according to an aspect of the present invention includes power supply device 100 described above, motor 93 for traveling to which electric power is supplied from power supply device 100, vehicle body 91 on which power supply device 100 and motor 93 are mounted, and wheels 97 driven by motor 93 to cause vehicle body 91 to travel.

A power storage device according to an aspect of the present invention includes power supply device 100 described above, and power supply controller 88 that controls charging and discharging of power supply device 100. Power supply controller 88 enables charging of battery cells 1 by electric power from an outside and performs control to charge battery cells 1.

### Advantageous Effect of Invention

The above power supply device has a feature that even in a battery stack in which a large number of battery cells are stacked and lengthened, deformation can be reduced and displacement of the battery cells can be suppressed.

### BRIEF DESCRIPTION OF DRAWINGS

FIG. 1 is a perspective view of a power supply device according to an exemplary embodiment of the present invention.

FIG. 2 is an exploded perspective view of the power supply device in FIG. 1.

FIG. 3 is a perspective view illustrating a manufacturing process of a binding bar illustrated in FIG. 2.

FIG. 4 is an enlarged cross-sectional view illustrating a fixing structure of the power supply device and a base plate illustrated in FIG. 1.

FIG. 5 is a perspective view of a power supply device according to another exemplary embodiment of the present invention.

FIG. 6 is a plan view of a power supply device according to another exemplary embodiment of the present invention.

FIG. 7 is an enlarged cross-sectional view illustrating another example of a bracket.

FIG. 8 is an enlarged cross-sectional view illustrating another example of the bracket.

FIG. 9 is a schematic front view illustrating an example of a binding bar provided with a truss member.

FIG. 10 is a schematic front view of a binding bar provided with a truss member having an X-shaped truss structure.

FIG. 11 is a schematic front view of a binding bar including a truss member having a Warren truss structure.

FIG. 12 is a schematic front view of a binding bar including a truss member having a Pratt truss structure.

FIG. 13 is a schematic front view of a binding bar including a truss member having a Howe truss structure.

FIG. 14 is a schematic front view of a binding bar including a truss member having a K truss structure.

FIG. 15 is a schematic front view of a binding bar including a truss member having a Finc truss structure.

FIG. 16 is a schematic front view of a binding bar including an arch member.

FIG. 17 is a cross-sectional perspective view illustrating an example of a truss member and an arch member.

FIG. 18 is a cross-sectional perspective view illustrating another example of a truss member and an arch member.

FIG. 19 is a cross-sectional perspective view illustrating another example of a truss member and an arch member.

FIG. 20 is a perspective view of an intermediate plate.

FIG. 21 is a block diagram illustrating an example in which a power supply device is mounted on a hybrid vehicle that is driven by an engine and a motor.

FIG. 22 is a block diagram illustrating an example in which a power supply device is mounted on an electric vehicle that is driven only by a motor.

FIG. 23 is a block diagram illustrating an example which applies to a power supply device for power storage.

### DESCRIPTION OF EMBODIMENTS

Hereinafter, the present invention will be described in detail with reference to the drawings. Note that, in the following description, terms (e.g., “top”, “bottom”, and other terms including those terms) indicating specific directions or positions are used as necessary; however, the use of those terms is for facilitating the understanding of the invention with reference to the drawings, and the technical scope of the present invention is not limited by the meanings of the terms. Furthermore, parts denoted by the same reference mark in a plurality of drawings indicate an identical or equivalent parts or members.

Further, the following exemplary embodiments illustrate specific examples of the technical concept of the present invention, and the present invention is not limited by the following exemplary embodiments. In addition, unless otherwise specified, dimensions, materials, shapes, relative arrangements, and the like of the constituent elements described below are not intended to limit the scope of the present invention, but are intended to be illustrative. The contents described in one exemplary embodiment and an example are also applicable to other exemplary embodiments and examples. Additionally, sizes, positional relationships, and the like of members illustrated in the drawings may be exaggerated for clarity of description.

A power supply device according to a first exemplary embodiment of the present invention includes a battery stack formed by stacking a plurality of prismatic battery cells, a pair of end plates, and binding bars. Each of the pair of end plates is disposed at an end of the battery stack in a stacked direction of the battery stack. Each of the binding bars has its both ends coupled to the pair of end plates. The binding bar is a metal sheet, and fixing piece of a bracket fixed to a base plate is provided so as to protrude from a surface of the binding bar in an integral structure. Further, the binding bar defines a middle part of the binding bar in a longitudinal direction and a width direction as a fixing piece region constituting a fixing piece, a straight part extending in the longitudinal direction along a part of the outer peripheral edge of the fixing piece region as a bending line extending in the longitudinal direction of the binding bar, and a region excluding the bending line on the outer peripheral edge of the fixing piece region as a cutting line. The cutting line is cut, and the fixing piece region is bent at the bending line and used as the fixing piece protruding outward. The original position of the fixing piece region is defined as an opening window. The bracket includes a fixing part fixed to the fixing piece, a rising part provided at a tip of the fixing part, and a base plate connector provided at a lower end of the rising part. The fixing piece is fixed to the fixing part of the bracket. The binding bar is fixed to the base plate via the bracket.

The above power supply device has a feature that even in a battery stack that becomes long by stacking a large number of battery cells, deformation can be reduced and displacement of the battery cells can be suppressed. In particular, in the above power supply device, the middle part of the binding bar of the metal sheet in the longitudinal direction and the width direction is set as a fixing piece region, and the straight part that is a part of the outer peripheral edge of the fixing piece region and extends in the longitudinal direction is set as a bending line, and the rest part is set as a cutting line. The fixing piece region is cut at the cutting line, and bent at the bending line which is straight to provide a fixing piece. The fixing piece provided in the binding bar in this structure is located in the middle part of the binding bar in the longitudinal direction and the width direction, and is provided integrally with the binding bar in a posture extending in the longitudinal direction. Since the fixing piece provided in the position and posture is fixed to the base plate via the bracket, the middle part of the binding bar both in the longitudinal direction and in the width direction is firmly fixed to the base plate. The binding bar, which fixes the middle in the longitudinal direction and the width direction to the base plate, is suppressed from being deformed even if the number of stacked battery cells increases and the battery stack becomes long. In particular, in the above power supply device, by firmly fixing the middle of the binding bar in the longitudinal direction and the width direction to the base plate, deformation of the binding bar can be suppressed in an ideal state, and displacement of the battery cells can be extremely effectively prevented.

A power supply device of a second exemplary embodiment of the present invention includes a set screw that penetrates the fixing piece and fixes the fixing piece to the fixing part of the bracket, and the fixing piece has a slit extending in the longitudinal direction of the binding bar. Then, the set screw is inserted through the slit to fix the fixing piece and the fixing part of the bracket.

In the above power supply device, since the set screw is inserted into the elongated slit provided in the fixing piece to fix the fixing piece and the bracket, the relative position between the fixing piece and the bracket can be shifted for the slit and fixed. The power supply device having this structure has a feature that it can be fixed to various base plates via a bracket without changing the shape of the binding bar. A power supply device used for multiple types of power sources is required to change the position of brackets fixed to a base plate depending on a device or a vehicle to be attached. The above power supply device can be fixed to any base plate with different fixing positions via the brackets by changing the position of the set screw to be inserted into the slit, so the power supply device can be standardized and fixed to multiple devices and vehicles.

A power supply device according to a third exemplary embodiment of the present invention has a fixing piece having a plurality of slits in which binding bars are arranged apart from each other in the longitudinal direction.

In a power supply device according to a fourth exemplary embodiment of the present invention, the binding bar has a plurality of fixing pieces arranged apart from each other in the longitudinal direction, and each fixing piece is provided with a slit.

In a power supply device according to a fifth exemplary embodiment of the present invention, each binding bar arranged on both sides of the battery stack has a plurality of fixing pieces, and each binding bar arranged on both sides of the battery stack has the plurality of fixing pieces placed in an asymmetrical position of each binding bar.

In a power supply device according to a sixth exemplary embodiment of the present invention, the end plates are fixed to the base plate.

In a power supply device according to a seventh exemplary embodiment of the present invention, the bending line is a straight part of the lower edge of the fixing piece region.

In a power supply device according to an eighth exemplary embodiment of the present invention, a truss member or an arch member made of an elongated bar material is fixed to a surface of the binding bar.

In the above-described power supply device, a decrease in the strength of the binding bar due to the opening window formed by providing the fixing piece can be reinforced by the truss member or the arch member, so that deformation of the battery stack can be reduced, and displacement of the battery cells can be suppressed. In particular, even in a power supply device in which a large number of battery cells are stacked to lengthen the battery stack, the above power supply device with a truss member or arch member prevents the binding bar from being deformed by the weight of the battery cells, and the battery cells from being displaced. In addition, since the middle of both the longitudinal direction and the width direction of the binding bar is fixed to the base plate with brackets, there is a feature that deformation of the binding bar can be further reduced. Therefore, even if the above power supply device is used as a high-output power supply device mounted on a vehicle and supplying electric power to a traveling motor, it is possible to effectively suppress the displacement of the battery cells due to vibration or impact. Further, in the above power supply device, in order to suppress the displacement of the battery cell, the elongated truss member or arch member is fixed to a surface of the binding bar without using a thick and heavy plate material to suppress the displacement with respect to a bending moment. Furthermore, since the middle of the binding bar in the longitudinal direction and the width direction is fixed to the base plate, it is possible to effectively suppress the displacement of the battery cells while reducing the weight of the binding bar.

A power supply device according to a ninth exemplary embodiment of the present invention includes a truss member or the arch member connected to a fixing piece.

Since the above power supply device can be fixed to the base plate by reinforcing the fixing piece with a truss member or an arch member, the power supply device can be fixed to the base plate with a stronger mounting structure.

In a power supply device according to a tenth exemplary embodiment of the present invention, an intermediate plate is stacked in the middle of the battery stack, and the intermediate plate is fixed to the binding bar.

### First Exemplary Embodiment

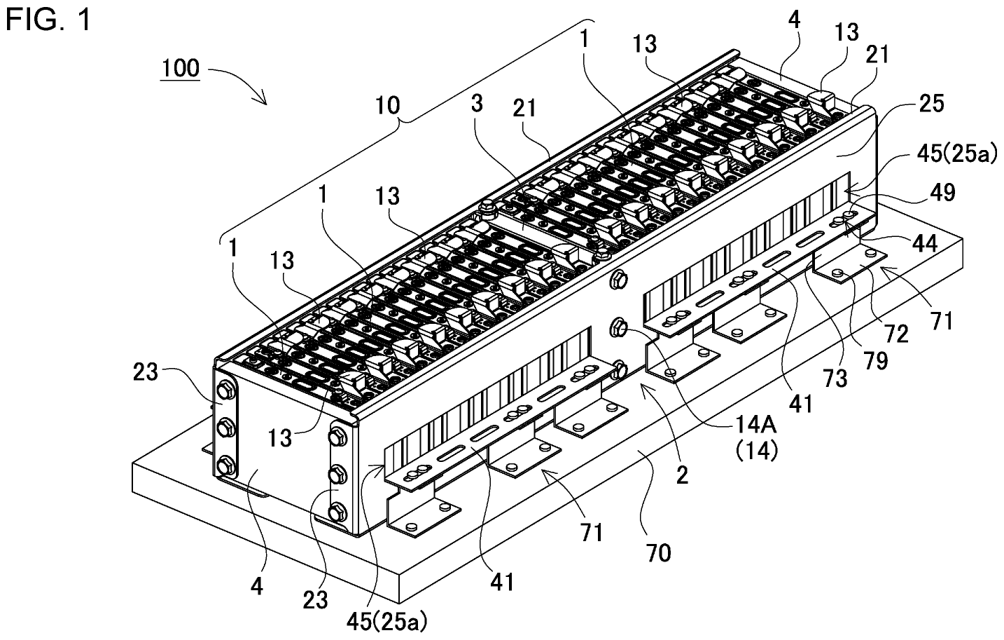

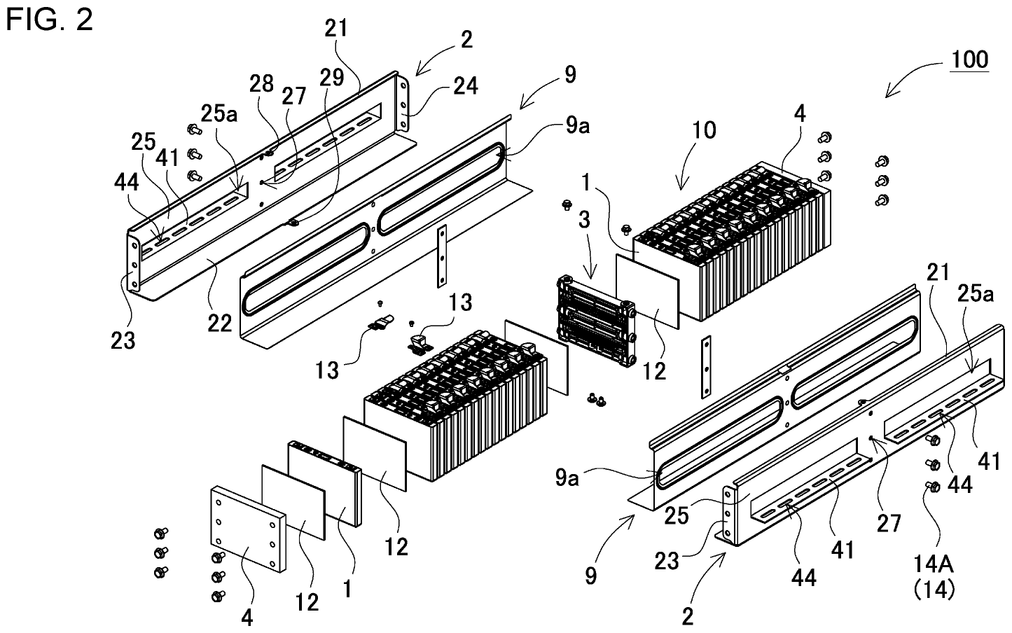

Power supply device 100 according to an exemplary embodiment of the present invention is illustrated in FIG. 1 and FIG. 2. Power supply device 100 illustrated in these drawings is an example of a vehicle-mounted power supply device. Specifically, power supply device 100 is mainly mounted on an electric vehicle such as a hybrid vehicle or an electric vehicle, and is used as a power source for supplying electric power to a traveling motor of the vehicle to drive the vehicle. However, the power supply device of the present invention can be used for electric vehicles other than the hybrid vehicle and the electric vehicle, and can also be used for applications other than electric vehicles, such as uninterruptible power supplies that require high output.

### (Power Supply Device 100)

Power supply device 100 illustrated in FIG. 1 and FIG. 2 includes battery stack 10 having a plurality of battery cells 1 stacked together, a pair of end plates 4, and binding bars 2. Each of the pair of end plates 4 is disposed at an end of battery stack 10 in a stacked direction of battery stack 10. Each of binding bars 2 has its both ends coupled to the pair of end plates 4. A profile of each of battery cells 1 is formed into a plate shape where a thickness is set smaller than a width, and a main surface of battery cell 1 has a rectangular shape. A plurality of battery cells 1 are stacked. Battery cells 1 are insulated from each other by an insulating material such as separator 12 sandwiched between battery cells 1. Further, end plates 4 are disposed on both end faces of battery stack 10 in a state where battery cells 1 are alternately stacked via separator 12. The pair of end plates 4 are fixed to binding bars 2, and fix battery stack 10 in a compressed state between end plates 4.

### (Battery Cell 1)

Battery cell 1 has a square exterior can having an outer shape where a thickness is set smaller than a width. The exterior can is formed in a shape of a bottomed cylinder with an opening at the top, and the opening part is closed with a sealing plate. The electrode assembly is accommodated in the exterior can. The sealing plate is provided with positive and negative electrode terminals and a gas discharge valve between the electrode terminals. The surface of the exterior can of each battery cell is covered with an insulating film (not illustrated) such as a heat-shrinkable tube. Since the surface of the sealing plate is provided with the electrode terminals and discharge valve, the surface is not covered with an insulating film and is exposed. A plurality of battery cells 1 are electrically connected to each other by bus bar 13 or the like. Bus bar 13 is formed by bending a metal sheet.

An insulating member such as separator 12 made from resin is interposed between adjacent battery cells 1 to insulate between them. The battery cells whose surfaces are coated with an insulating film can also be stacked without using a separator.

### (Separator 12)

As illustrated in the exploded perspective view of FIG. 2, separator 12 is interposed between opposing main surfaces of adjacent battery cells 1 to insulate them. Each of separators 12 is formed into the shape of a thin plate or sheet using an insulating material. Each of illustrated separators 12 has a plate shape having a size substantially equal to a facing surface of battery cell 1, and such separator 12 is interposed between adjacent battery cells 1 so that adjacent battery cells 1 are electrically isolated from each other. As the separator, a separator that forms a cooling-gas flow path between adjacent battery cells can be used, and a cooling gas can be forcibly blown into the flow path to cool battery cells. Separator 12 is made of an insulating material. For example, by using a resin such as plastic, it can be constructed lightweight and inexpensively. Separator 12 is formed of a hard member. However, separator 12 may be formed of a member having flexibility. In particular, in separator 12 in which a cooling gap is not formed, separator 12 may be formed of a thin sheet-shaped material having flexibility. In a case where a separator having an adhesive surface coated on one side as a sheet shape is used, it can be easily attached to a region requiring insulation such as a main surface and some side surfaces of battery cell 1. Further, by forming the separator in a sheet-shape, the separator can be easily made thin and hence, an increase in a thickness or a weight of battery stack 10 can be also suppressed.

### (End Plate 4)

The pair of end plates 4 are disposed on both the end surfaces of battery stack 10 in which battery cells 1 and separators 12 are alternately stacked, and battery stack 10 is fastened by the pair of end plates 4 in a pressurized state. End plate 4 is made of a material exerting sufficient rigidity, such as metal. Notably, the end plate can be made of a resin material, or configured such that the end plate made of a resin is reinforced by a member made of metal. In the example of FIG. 2, end plate 4 is composed of one metal sheet.

### (Binding Bar 2)

Both ends of each of binding bars 2 are fixed to end plates 4. As illustrated in FIGS. 1 and 2, binding bar 2 is disposed on the side surface of battery stack 10 on which end plates 4 are stacked on both ends, and fastens battery stack 10 with both ends being fixed to the pair of end plates 4. Binding bar 2 is formed in a plate shape extended in the battery stacking direction of battery stack 10. Specifically, binding bar 2 has flat plate-shaped fastening main surface 25 that covers the side surface of battery stack 10, and first bent piece 21, second bent piece 22, third bent piece 23, and fourth bent piece 24 as bent pieces whose edges are bent. First bent piece 21 is an upper end bent piece in which one of the end edges in the longitudinal direction of fastening main surface 25. In this exemplary embodiment, first bent piece 21 is an upper end bent piece formed by bending an upper end side of fastening main surface 25 Further, second bent piece 22 is a lower end bent piece in which the other side of the end edges in the longitudinal direction of fastening main surface 25. In this exemplary embodiment, second bent piece 22 is a lower end bent piece formed by bending a lower end side of fastening main surface 25. Third bent piece 23 is an end edge of fastening main surface 25 which intersects with the longitudinal direction. In this exemplary embodiment, third bent piece 23 is an end plate fixing piece which is formed by partially bending a front side of fastening main surface 25. Fourth bent piece 24 is an end edge of fastening main surface 25 which intersects with the longitudinal direction. In this exemplary embodiment, fourth bent piece 24 is an end plate fixing piece which is formed by partially bending a rear side of fastening main surface 25. By bending each end edge of binding bar 2 in this way, both the cross-sectional shape in the longitudinal direction and the cross-sectional shape intersecting the longitudinal direction are formed in a U-shape. Accordingly, the rigidity of binding bar 2 can be increased.

Further, binding bar 2 is fixed to end plate 4 by screwing or the like. Further, the upper end bent piece partially covers a corner of an upper surface of battery stack 10, and the lower end bent piece partially covers a corner of a lower surface of battery stack 10 to increase the strength.

Such binding bar 2 is manufactured by bending a metal sheet. Further, binding bar 2 needs to have sufficient strength so as to hold battery stack 10 for a long period of time. For this purpose, high tensile strength steel, general steel, stainless steel, an aluminum alloy, a magnesium alloy, and the like that are excellent in rigidity and heat transfer, or a combination of these materials can be used. In the example of FIG. 2, for example, a binding bar made of Fe-based metal is used.

The position where binding bars 2 are disposed may be side surfaces of battery stack 10, or may be upper and lower surfaces of battery stack 10. Further, the structure for fixing binding bar 2 to end plate 4 is not limited to screwing. A known fixing structure such as riveting, crimping, welding, or bonding can be appropriately used. As illustrated in FIG. 2, to enable the supply of a cooling gas between battery cells 1, opening 25a may be formed in fastening main surface 25 of the binding bar. Further, binding bar 2 can be reduced in weight by providing a plurality of openings 25a. Further, binding bar 2 having opening 25a can blow air to opening 25a and forcibly blow air between battery cells 1 of battery stack 10 to cool battery cells.

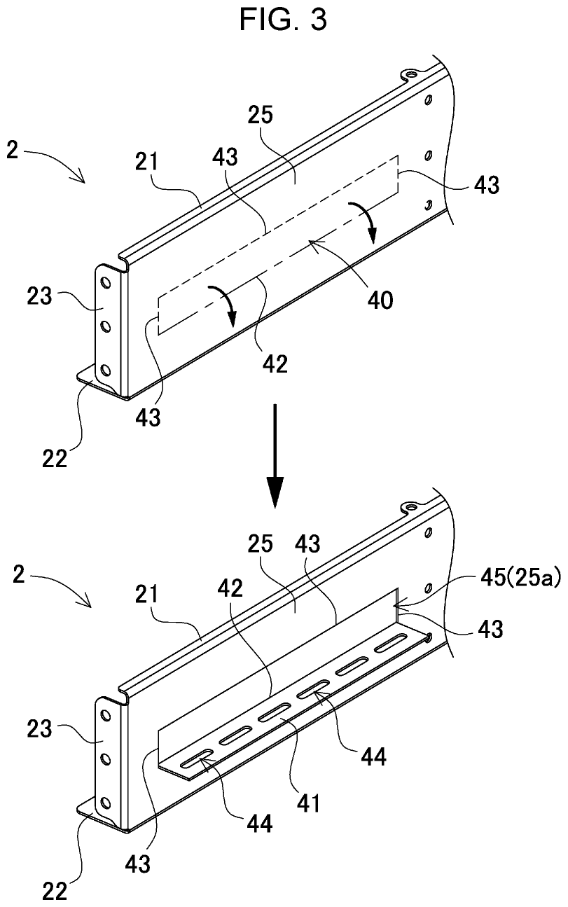

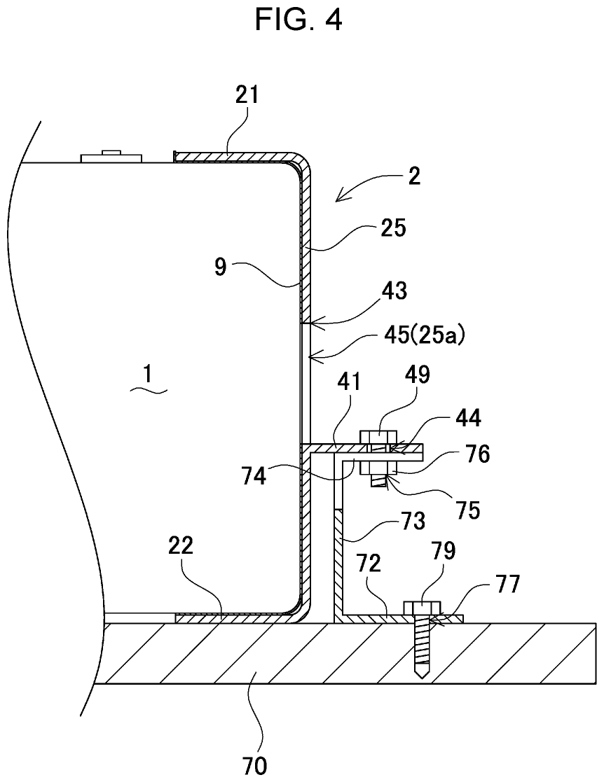

Binding bar 2 illustrated in FIGS. 3 and 4 is formed by pressing a metal sheet to provide fixing piece 41 protruding from a surface of binding bar 2 in an integral structure. Fixing piece 41 is fixed to base plate 70 such as a chassis of a vehicle via brackets 71. Fixing piece 41 is provided by bending a part of the metal sheet of binding bar 2 outward. Binding bar 2 defines the middle part of binding bar 2 in the longitudinal direction and the width direction as fixing piece region 40 constituting fixing piece 41, and fixing piece region 40 is bent so as to extend horizontally outward to provide fixing piece 41. Fixing piece region 40 defines a straight part extending in the longitudinal direction at a part of the outer peripheral edge as bending line 42 extending in the longitudinal direction of binding bar 2, and a region excluding bending line 42 on the outer peripheral edge of fixing piece region 40 as cutting line 43. Cutting line 43 is cut, and bending line 42 is bent at a right angle and fixing piece region 40 is used as fixing piece 41 protruding outward. The original position of fixing piece region 40 is defined as opening window 45. In binding bar 2 of FIG. 3, fixing piece region 40 is formed as an elongated rectangle in the longitudinal direction, and bending line 42 is bent at a right angle so as to be parallel to a lower edge of binding bar 2 to provide fixing piece 41 in a horizontal posture. Further, in binding bar 2 of FIG. 3, a straight part of the lower edge of fixing piece region 40 which is a rectangle is defined as bending line 42, and an upper part of bending line 42 is defined as opening window 45.

Fixing piece 41 is provided with slits 44 extending in the longitudinal direction. Each of slits 44 has a width that allows a threaded part of set screw 49 to be inserted and a screw head of set screw 49 to be locked. Set screw 49 is screwed into a female screw hole of bracket 71 by inserting a screw part into slit 44, or a nut is screwed from the tip part to fix fixing piece 41 to bracket 71.

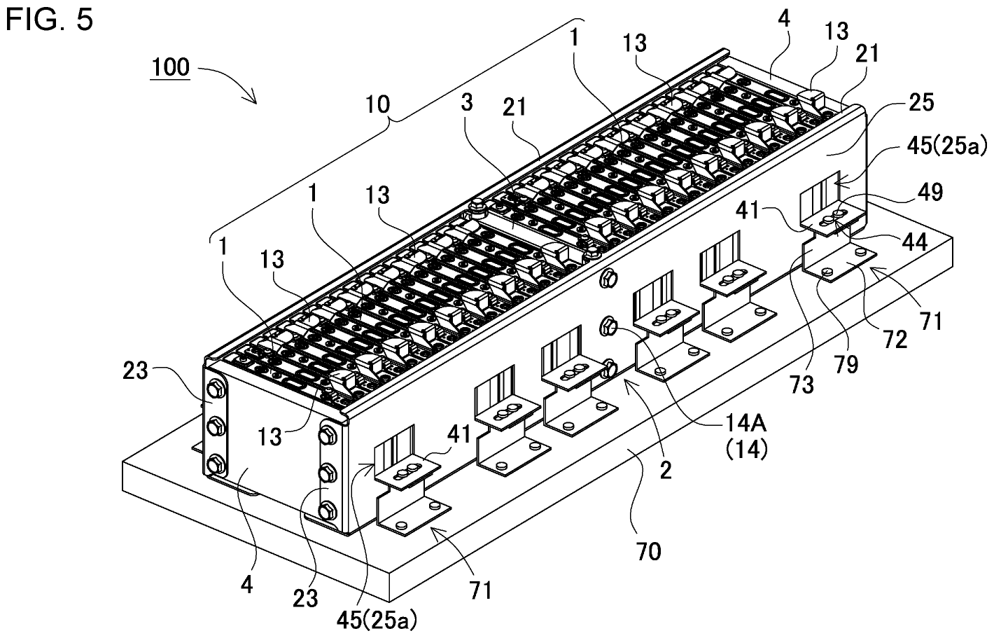

In power supply device 100 illustrated in the perspective view of FIG. 1, fixing piece 41 is lengthened in the longitudinal direction of binding bar 2 and a plurality of slits 44 are provided side by side in the longitudinal direction such that power supply device 100 can be fixed to base plate 70 having different mounting positions. Power supply device 100 having this structure has a plurality of slits 44 (six in the figure) in which the length of fixing piece 41 is preferably 50% or more, more preferably 60% or more, still more preferably 70% or more of the total length of binding bar 2. In power supply device 100 illustrated in the perspective view of FIG. 5, a plurality of fixing pieces 41 are provided on each of binding bars 2 arranged on both sides of battery stack 10 apart from each other in the longitudinal direction, and slits 44 are provided in each fixing piece 41.

Since bracket 71 can be fixed to a free position in the longitudinal direction of binding bar 2 in above-described power supply device 100, bracket 71 can be fixed to a plurality of types of base plates 70 having different mounting positions without changing binding bar 2. It also has the advantage of being able to be fixed in an optimum position of base plate 70. In power supply device 100 used for a plurality of types of power supplies, the shape of the base plate differs depending on a device or a vehicle to be mounted, and the mounting position of each bracket to be fixed to the base plate changes. In above-described power supply device 100, the position of each set screw 49 can be freely changed by selecting slit 44 through which set screw 49 is inserted and adjusting the position where set screw 49 is inserted into slit 44. Accordingly, while standardizing binding bars 2 of power supply device 100, power supply device 100 can be securely fixed to various devices and vehicles with different base plates 70.

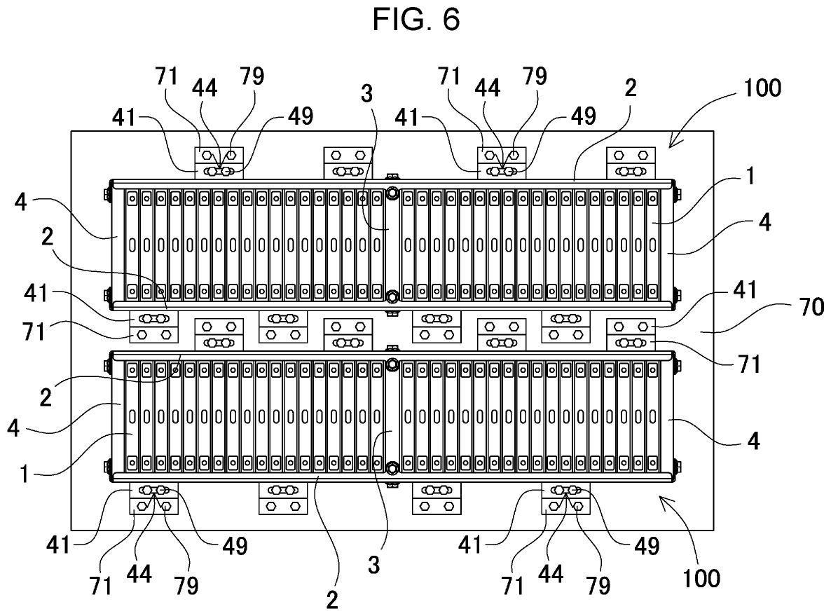

In power supply device 100 having a plurality of fixing pieces 41 provided on binding bars 2, it has a feature that fixing pieces 41 can be disposed at asymmetric positions of each binding bar 2 disposed on both sides of battery stack 10 to be fixed to base plate 70 while coming close to another power supply device. This is because, as illustrated in the plan view of FIG. 6, fixing pieces 41 of one power supply devices, which are disposed adjacent to each other, can be disposed between other fixing pieces 41 of another power supply device, and power supply devices 100 can be arranged close to each other.

### (Bracket 71)

Each bracket 71 illustrated in FIG. 1 and FIG. 4 is provided with fixing part 74 fixed to fixing piece 41 formed by pressing a metal sheet, rising part 73 having fixing part 74 at the upper end, and base plate connector 72 provided at the lower end of rising part 73. Bracket 71 is manufactured by processing a metal sheet having a same strength as that of binding bar 2, or a metal sheet having a strength equal to or higher than that of binding bar 2. Preferably, bracket 71 is made of high-strength steel of the same strength as that of binding bar 2, and is made of a metal sheet having a same thickness as that of binding bar 2 or thicker than binding bar 2. In bracket 71 having the shape illustrated in FIG. 4, the upper end of rising part 73 is bent at a right angle to provide fixing part 74, and the lower edge of rising part 73 is bent at a right angle to provide base plate connector 72. Fixing part 74 includes female screw hole 75 for screwing and fixing set screw 49 inserted into slit 44 of fixing piece 41. In bracket 71 of FIG. 4, a through hole for set screw 49 is provided in fixing part 74, and nut 76 into which set screw 49 is screwed is fixed to the lower surface of fixing part 74 by a method such as welding. However, nut 76 may be screwed into the lower end of set screw 49 and fixed to set screw 49 without being welded to fixing part 74.

In bracket 71 of FIG. 4, fixing part 74 and base plate connector 72 are bent to a same side so that the cross-sectional shape is U-shaped. Further, in bracket 71 illustrated in the figure, the width of fixing part 74 is narrower than the width of base plate connector 72, and insertion holes 77 for fixing screws 79 are provided at both ends of base plate connector 72 such that fixing part 74 does not overlap with both ends of base plate connector 72 in a plan view. As a result, bracket 71 can be screwed into insertion hole 77 of base plate connector 72 by inserting fixing screws 79 from above while avoiding fixing part 74. In bracket 71 having the shape, base plate connector 72 is fixed to base plate 70 with fixing screws 79, and then fixing piece 41 is connected to fixing part 74 with set screw 49.

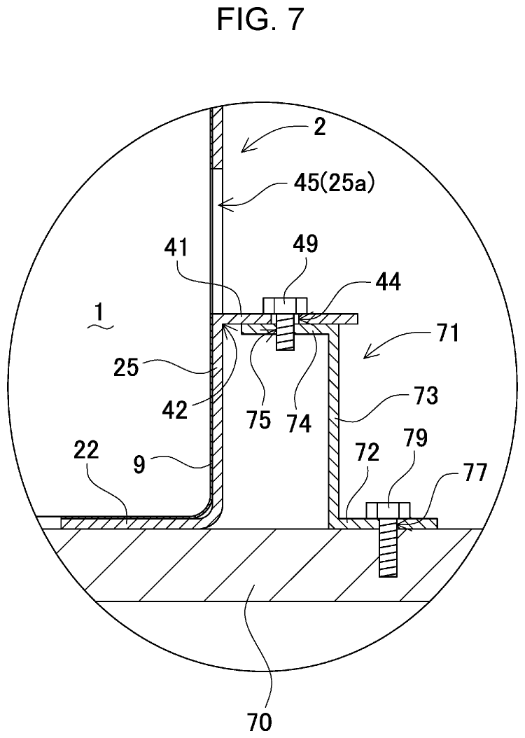

In addition, bracket 71 can be configured as illustrated in FIG. 7. In bracket 71 of FIG. 7, fixing part 74 and base plate connector 72 are bent to opposite sides to each other, and fixing part 74 has a shape protruding from the rising part toward a surface of binding bar 2, and base plate connector 72 is formed into a shape protruding to the opposite side of fixing part 74. In bracket 71 having the shape, base plate connector 72 can be fixed to base plate 70 with fixing screws 79 while fixing piece 41 is connected to fixing part 74 with set screw 49. Bracket 71 illustrated in the figure is provided with female screw hole 75 for fixing set screw 49 by screwing set screw 49 into fixing part 74.

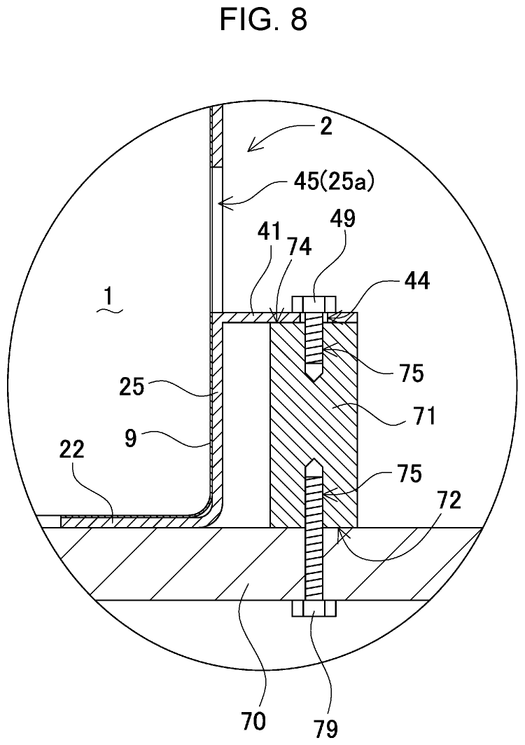

However, bracket 71 may be configured without specifying the above shape, for example, as illustrated in the cross-sectional view of FIG. 8, in which bracket 71 is used as a fixing base and female screw holes 75 are provided on the upper surface and the lower surface of bracket 71. The upper surface of bracket 71 is used as fixing part 74, and the lower surface of bracket 71 is used as base plate connector 72. In bracket 71, set screw 49 penetrating fixing piece 41 is screwed into female screw hole 75 on the upper surface of fixing part 74, and fixing screw 79 penetrating base plate 70 is screwed into female screw hole 75 of base plate connector 72. Fixing piece 41 is fixed to fixing part 74 on the upper surface of bracket 71, and base plate connector 72 on the lower surface of bracket 71 is fixed to base plate 70.

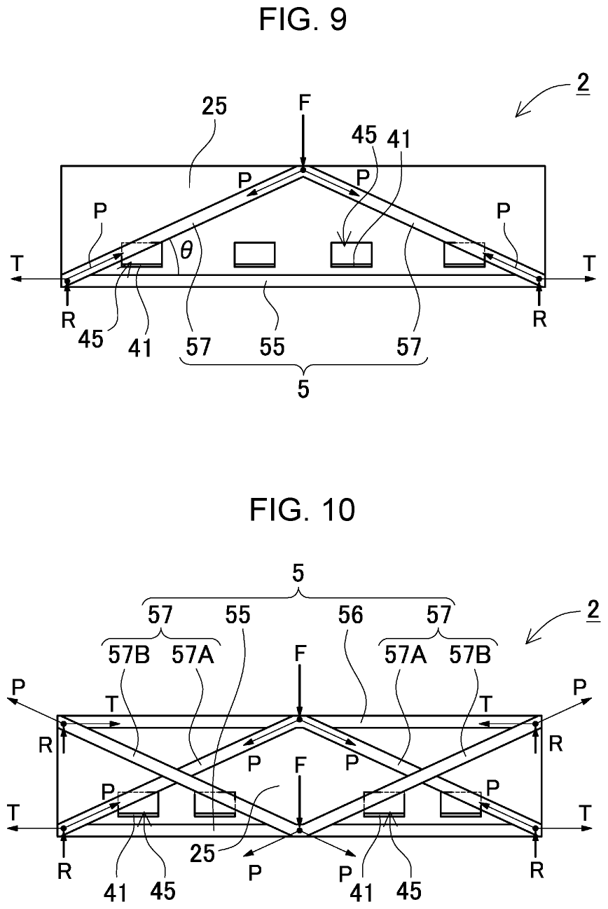

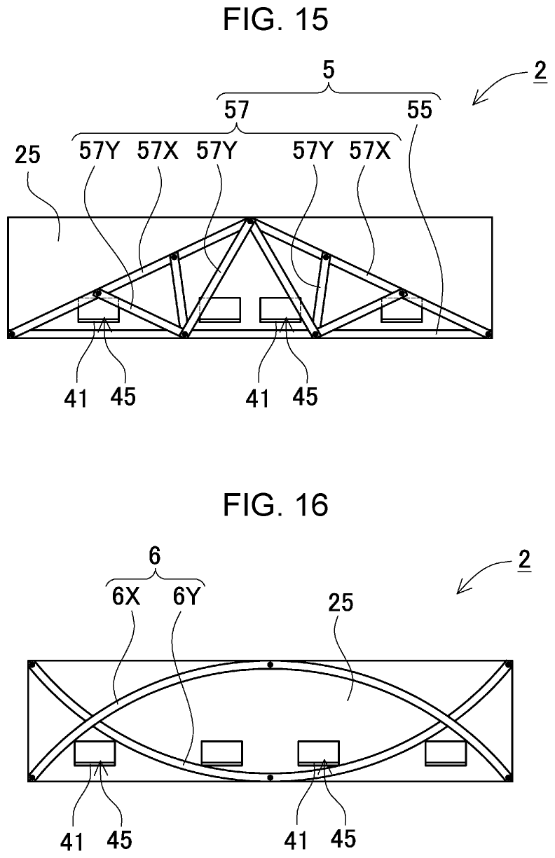

Further, truss member 5 or arch member 6 can also be fixed to a surface of binding bar 2 to increase the bending strength. Binding bars 2 illustrated in FIGS. 9 to 15 have truss member 5 fixed to the surface thereof, and binding bar 2 of FIG. 16 has arch member 6 fixed to the surface thereof. Binding bars 2 of FIGS. 9 to 15 fix truss member 5 to a surface of fastening main surface 25 in order to improve the strength of battery cell 1 against the bending moment in the stacking direction, that is, the longitudinal direction. In binding bar 2 in FIG. 16, arch member 6 is fixed to a surface of fastening main surface 25. Truss member 5 and arch member 6 are preferably made of a same material as that of binding bar 2, for example, both are made of high-strength steel to equalize the thermal expansion. Such binding bar 2 can suppress distortion due to temperature changes. However, truss member 5 and arch member 6, and binding bar 2 do not necessarily have to be made of a same metal. For example, truss member 5 and arch member 6 can be made of a metal having a smaller or larger thermal expansion than that of binding bar 2.

Truss member 5 and arch member 6 fixed to the surface of binding bar 2 reinforce binding bar 2 to reduce deformation with respect to a bending moment and suppress displacement of battery cell 1. In power supply device 100 used in an environment subject to vibration or impact, the displacement of battery cell 1 in the central part increases as battery stack 10 becomes longer, but binding bar 2 reinforced by truss member 5 and arch member 6 has a small displacement with respect to a bending moment, and can suppress displacement of battery cell 1 due to vibration or impact. Further, in binding bar 2 provided with fixing piece 41 by bending a part of a metal sheet, although the strength is reduced by opening window 45 formed by bending fixing piece 41 outward, it can be reinforced with truss member 5 or arch member 6 to reduce deformation with respect to a bending moment.

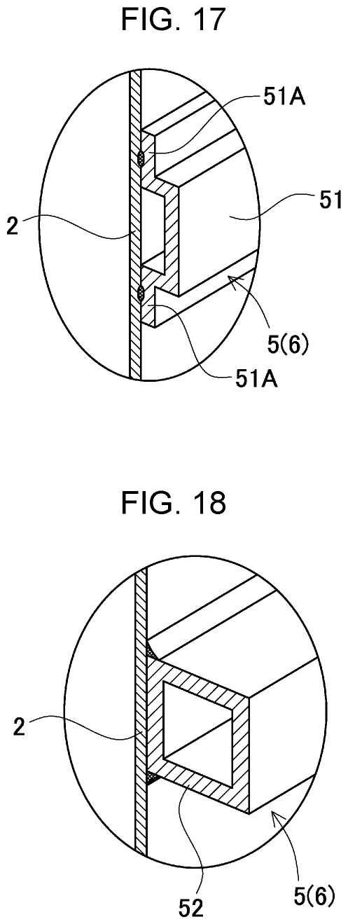

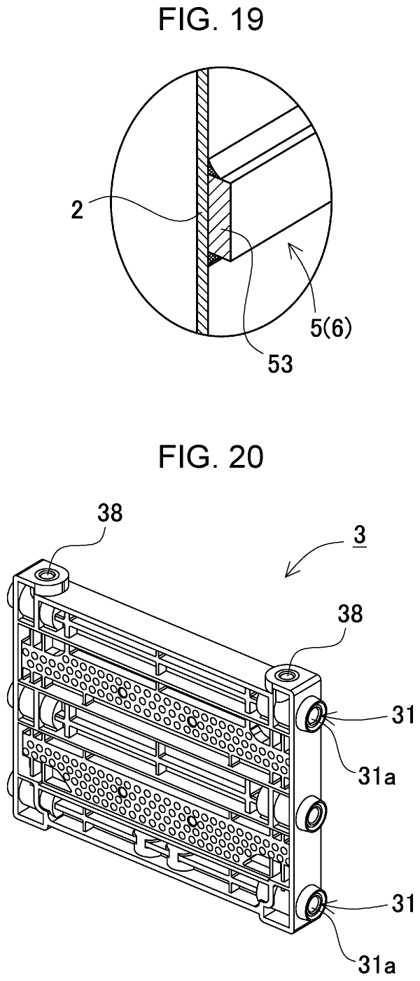

Since truss member 5 and arch member 6 suppress the deformation of binding bar 2 by a tensile stress and a compressive stress, an elongated rod having sufficient strength against a stress received in the longitudinal direction is used. FIGS. 17 to 19 illustrate cross-sectional perspective views of truss member 5 and arch member 6. Truss member 5 and arch member 6 in FIG. 17 are made by pressing metal sheet 51 into a groove shape, and flanges 51A are provided on both sides. Truss member 5 and arch member 6 can be fixed to binding bar 2 by welding flanges 51A. Truss member 5 and arch member 6 in FIG. 18 are square metal pipe 52, and both sides are welded to binding bar 2. Truss member 5 and arch member 6 of metal pipe 52 can be securely welded and fixed to binding bar 2 on both sides. Truss member 5 and arch member 6 of FIG. 19 are fixed to binding bar 2 by welding both sides with metal rod 53.

Truss member 5 in FIG. 9 includes lower string 55 fixed along the lower edge of binding bar 2 and two inclined strings 57 fixed at both ends thereof to lower string 55. Lower string 55 and two inclined strings 57 are disposed in a triangle, and two inclined strings 57 have the upper end fixed to the upper edge of a center of binding bar 2 and the lower end to both ends of lower string 55. In power supply device 100 in which intermediate plate 3 is stacked in a central part of battery stack 10, the upper end part of inclined strings 57 is fixed to intermediate plate 3, so that deformation of the central part of battery stack 10 in the vertical direction can be effectively suppressed. Power supply device 100 having this structure can securely fix the central part of binding bar 2 to intermediate plate 3 by screwing set screw 14A penetrating inclined strings 57 and binding bar 2 to intermediate plate 3.

Truss member 5 of FIG. 9 supports a load F acting downward on the central part of binding bar 2 by a tensile stress T of lower string 55 and a compressive stress P of inclined strings 57, as illustrated by arrows in the figure. The tensile stress T of lower string 55 and the compressive stress P of inclined string 57 change depending on an angle (0) between lower string 55 and inclined strings 57. The tensile stress T and the compressive stress P of inclined strings 57 can be expressed as follows using the angle (0) between lower string 55 and inclined strings 57 and the load F.

P=F/2 sin θ

T=F/2 tan θ

Here, in FIG. 9, each arrow R indicates an upward reaction force R acting on the connecting points at both ends of lower string 55, and R=F/2 is satisfied. The reaction force R is equal to the resultant force of the tensile stress T and the compressive stress P at the connection points at both ends of lower string 55. As an example, in truss member 5 in which the angle (θ) between lower string 55 and tilted string 57 is 30 degrees, the tensile stress T of lower string 55 is 86% of the load F, and the compressive stress P of inclined string 57 is equal to the load F. Lower string 55 and inclined string 57 are made of a bar material having a strength that can withstand the stress and elastically deform, and the deformation under the stress becomes smaller than a set value.

Truss member 5 suppresses the deformation of binding bar 2 by tensile stress T and compressive stress P acting in the longitudinal direction. Therefore, truss member 5, which constitutes lower string 55 and inclined strings 57, has at least its ends fixed to binding bar 2 to suppress the deformation of binding bar 2. Truss member 5 is preferably welded and fixed to binding bar 2. However, it is not necessary to specify the fixing method of truss member 5 and binding bar 2 for welding. For example, although not illustrated, truss member 5 and binding bar 2 can be fixed by bonding or screwing. Truss member 5 has both ends fixed to binding bar 2, but the whole member can be fixed to binding bar 2, or a plurality of places thereof can be fixed to binding bar 2.

Truss member 5 is not specified in the shape illustrated in FIG. 9, and the bending of binding bar 2 can be suppressed by the following structures illustrated in FIGS. 10 to 15. In truss member 5 of FIG. 10, upper string 56 is fixed to the upper edge of binding bar 2, and lower string 55 is fixed to the lower edge. The upper ends of crossing inclined strings 57A and 57B that are formed into an X-shape crossing inclined strings 57, are respectively fixed to one end of upper string 56 and the middle part of upper string 56 (intermediate plate 3), and the lower ends of crossing inclined strings 57B and 57A are fixed to one end of lower string 55 and the middle part of lower string 55 (intermediate plate 3). This binding bar 2 is fixed to the central part of battery stack 10 or to intermediate plate 3, when battery stack 10 includes intermediate plate 3, so that the central part of battery stack 10 can be effectively suppressed from being deformed in the vertical direction. In this truss member 5, in a state where a load acts downward on a middle part of binding bar 2, a compressive stress P acts on inclined strings 57B, and a compressive stress T acts on lower string 55, to a load F that acts downward on an apex of a triangle formed by lower string 55 and two inclined strings 57B, and a compressive stress T acts on upper string 55 and a tensile stress P acts on inclined strings 57A to a load F that acts downward on an apex of an inverted triangle formed by upper string 56 and two inclined strings 57A to suppress bending of binding bar 2. Further, in FIG. 10, each arrow R indicates upward reaction force R acting on the connecting points at both ends of lower string 55 and upper string 56, and R=F/2 is satisfied. This reaction force R is equal to a resultant force of the tensile stress T and the compressive stress P at the connecting points at both ends of lower string 55, and is also equal to a resultant force of the tensile stress P and the compressive stress T at the connecting points at both ends of upper string 56.

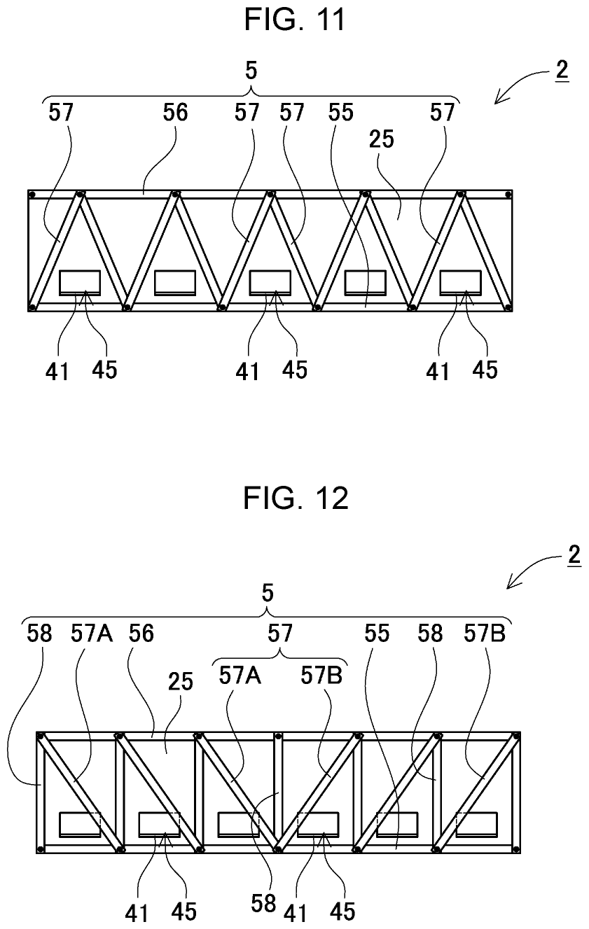

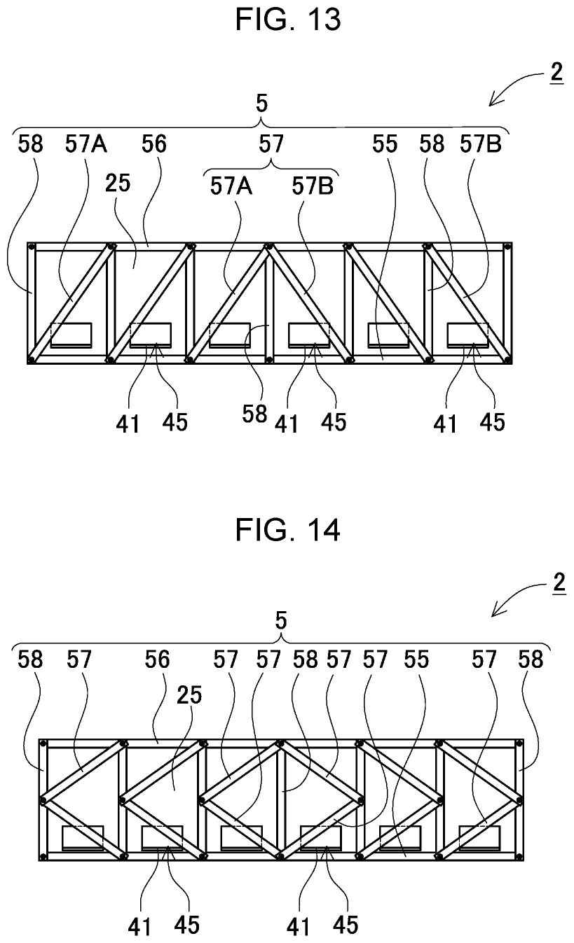

Truss member 5 in FIG. 11 has a truss structure as a Warren truss, and constitutes upper string 56, lower string 55, and inclined strings 57. Ends of a plurality of inclined strings 57 are fixed to upper string 56 and lower string 55, while disposed in a zigzag shape, triangles are arranged with upper string 56, inclined strings 57, and lower string 55 in a shape such that the triangles are alternately turned upside down in the longitudinal direction. Truss member 5 in FIG. 12 has a truss structure as a Pratt truss, and truss member 5 in FIG. 13 has a Howe truss. In these structures, vertical strings 58 are fixed to lower string 55 and upper string 56 while spacing at intervals, and inclined strings 57 are fixed diagonally to a square defined by upper string 56, lower string 55, and vertical strings 58. In the Pratt truss of FIG. 12, lower ends of inclined strings 57A and 57B are connected to a connection point between a lower end of central vertical string 58 and lower string 55, and inclined strings 57A and 57B in the central part are disposed in a V shape, and is fixed to binding bar 2. Inclined strings 57A and 57B on both sides of central inclined strings 57A and 57B are inclined in the same direction as that of central inclined strings 57A and 57B. In the Howe truss of FIG. 13, upper ends of inclined strings 57A and 57B are connected to a connection point between an upper end of central vertical string 58 and upper string 56, and central inclined strings 57A and 57B are disposed in an inverted V shape, and is fixed to binding bar 2. Inclined strings 57A and 57B on both sides of central inclined strings 57A and 57B are fixed so as to be inclined in the same direction as that of central inclined strings 57A and 57B fixed to binding bar 2. Furthermore, truss member 5 in FIG. 14 has a truss structure as a K truss, and has both one ends of two inclined strings 57 are fixed to vertical string 58 in the central part so as to provide three sets of triangles inside a square surrounded by upper string 56, lower string 55, and vertical strings 58. Each one end of two inclined strings 57 are fixed to central vertical string 58, and each of the other end is fixed to an opposing corner of the square. Since this truss structure arranges three sets of triangles inside the square, deformation of binding bar 2 with respect to a bending moment can be further reduced. Further, truss member 5 in FIG. 15 has a truss structure as a Finc truss, and three sub-inclined strings 57Y are connected to each main inclined string 57X constituting the truss structure in FIG. 9. In total, eight inclined strings 57 are fixed in the truss structure. The inside of triangles formed by main inclined strings 57X and lower string 55 is divided into seven triangles by sub-inclined strings 57Y, and deformation of binding bar 2 with respect to a bending moment is further reduced.

Further, in binding bar 2 in FIG. 16, arch member 6 is fixed to a surface of binding bar 2. In binding bar 2 in this figure, two arch members 6 are fixed to binding bar 2 in an upside down state. One arch member 6X fixes the central part of the arch member to the center of the upper edge of binding bar 2 and both ends of the arch member to both ends of the lower edge of binding bar 2. Other arch member 6Y fixes the center of the other arch member to the center of the lower edge of binding bar 2, and both ends of the other arch member are fixed to both ends of the upper edge of binding bar 2. Arch member 6X, which fixes the central part to the upper edge of binding bar 2, suppresses downward deformation of the central part of battery stack 10 by the compressive stress. Further, arch member 6Y, which fixes the central part to the lower edge of binding bar 2, suppresses upward deformation of the central part of battery stack 10 by the compressive stress. In a power supply device used in an environment where battery stack 10 receives a load in a direction in which the central part is lowered by the weight of battery cell 1 and is subjected to vertical vibration, a vibration force acts such that the central part moves up and down in a state of vertical vibration. Therefore, binding bar 2 that flips two arch members 6X and 6Y upside down and fixes them to binding bar 2 can dispose battery cells 1 in a fixed position with less vertical deformation of the central part of binding bar 2 in the vertical direction.

Metal binding bar 2 can be provided with an insulating structure between binding bar 2 and battery stack 10 in order to prevent a short circuit with the exterior can of battery cell 1. In the example of FIG. 2, insulating material 9 is interposed between metal binding bar 2 and battery stack 10. Insulating material 9 is composed of an insulating member such as a resin sheet or paper. Further, the shape of insulating material 9 is substantially the same as that of binding bar 2, so that a side surface of battery stack 10 does not touch binding bar 2. In the example of FIG. 2, insulating material 9 also has opening region 9a opened in insulating material 9 so as not to block opening window 45 provided in binding bar 2.

### (Intermediate Plate 3)

In battery stack 10 of FIGS. 1 and 2, intermediate plate 3 is stacked in the middle part. Battery stack 10 in FIG. 2 is provided with one intermediate plate 3 in the central part, but a long battery stack may be provided with a plurality of intermediate plates in the middle, and depending on the length of the battery stack, the intermediate plate may not be used. Intermediate plate 3 is fixed to binding bar 2. Therefore, binding bar 2 has intermediate plate fixing part 27 for fixing intermediate plate 3 in the middle of binding bar 2 in the longitudinal direction. On the other hand, intermediate plate 3 fixes metal collar 31 to be fixed to intermediate plate fixing part 27. In a case where the battery stack has sufficient rigidity, it is also possible not to use the intermediate plate as described above.

In above-described power supply device 100, intermediate plate 3 is arranged in the middle part of battery stack 10, both sides of intermediate plate 3 are connected to binding bar 2, and fixing piece 41 provided in the middle part of binding bar 2 is further fixed to base plate 70 via bracket 71. This structure has a feature that displacement of battery cells 1 can be further reduced even in power supply device 100 in which the number of stacked battery cells 1 becomes large and battery stack 10 is lengthened. In particular, power supply device 100 having the above structure by fixing truss member 5 or arch member 6 to the surface of binding bar 2 has the feature that displacement of battery cells 1 can be extremely reduced even if the number of battery cells increases and battery stack 10 is lengthened. This is because the middle part of binding bar 2 is fixed to base plate 70 via fixing piece 41 and bracket 71 to suppress the displacement of battery cells 1, the middle part of binding bar 2 to suppress the displacement is fixed to intermediate plate 3, and the displacement of intermediate plate 3 is suppressed, and intermediate plate 3 that is not displaced further suppresses the displacement of the middle part of battery stack 10.

Further, the effect of suppressing a variation in thickness between the battery cells by intermediate plate 3 can be obtained. By arranging intermediate plate 3 in the middle as illustrated in FIG. 2, since battery stack 10 can be divided into two parts and held narrowly between one surface of intermediate plate 3 and one end plate 4, and between other surface of intermediate plate 3 and other end plate 4, the number of layers of divided battery stack 10 can be halved, the cumulative error of the variation in the thickness of battery cell 1 and separator 12 is reduced, and they can be easily fastened with binding bar 2. In other words, it is possible to suppress variations in the fastening state of binding bars between power supply devices, and it is possible to maintain the fastening state of each power supply device at a constant level and improve reliability.

The position where intermediate plate 3 is arranged on binding bar 2 is preferably approximately the center of binding bar 2 in the longitudinal direction. However, it is not hindered that the intermediate plate is disposed and fixed at a position slightly displaced toward either side in the longitudinal direction from the center of binding bar 2. In particular, it is possible to arrange the intermediate plate at the center of binding bar 2 when the number of battery cells to be stacked is an even number, but it is difficult to arrange the intermediate plate at the center of binding bar 2 when the number of battery cells is an odd number. The present invention can also be suitably used in such an aspect.

A perspective view of intermediate plate 3 is illustrated in FIG. 20. Intermediate plate 3 is preferably made of insulating plastic. However, it is not necessary to form the entirety of the intermediate plate using plastic. For example, although not illustrated, both side parts and upper and lower parts of a square shape, that is, an outer peripheral parts of the intermediate plate, and both surfaces of the intermediate plate may be made of plastic, and other parts of the intermediate plate may be made of metal. The intermediate plate may have a structure where the intermediate plate can be manufactured by insert-molding a metal sheet into plastic so that surfaces of the intermediate plate are insulated by plastic. Intermediate plate 3 described above can be reliably insulated from battery cells 1 stacked on both surfaces of intermediate plate 3. As a resin material for molding the intermediate plate, for example, crystalline polymer (LCP), polyphenylene sulfide (PPS), polyether sulfone (PES), polybutylene terephthalate (PBT), polyamideimide (PAI), polyphthalamide (PPA), polyether ether ketone (PEEK), or polycarbonate can be used.

### (Metal Collar 31)

Intermediate plate 3 has metal collars 31 fixed on both sides to fix binding bar 2. Metal collars 31 are preferably insert-molded and fixed to intermediate plate 3. Although not illustrated, each metal collar is provided with a ring-shaped groove or a large number of protrusions on the outer peripheral surface in order to firmly fix it to intermediate plate 3. Metal collar 31 insert-molded and fixed is firmly fixed in the exact position of intermediate plate 3. However, the metal collar can be glued or press-fitted to be fixed to the intermediate plate. The hybrid structure in which metal collar 31 is insert-molded and fixed to plastic intermediate plate 3 makes it possible to increase reliability by making a fixing part with binding bar 2, that requires strength and durability, made of metal, while making intermediate plate 3 with resin to be lightweight and easy to mold. Although intermediate plate 3 described above is made of plastic, and metal collar 31 is insert-molded and fixed, the metal collar can also be integrated with the intermediate plate. A part of this intermediate plate is made of metal and has a structure integrated with a metal collar, and the surface of the metal intermediate plate is insulated with plastic or the like. This intermediate plate can be achieved by a structure in which the part to be integrally molded with the metal collar is made of die-cast aluminum and the surface is insulated with plastic or the like.

Intermediate plate 3 has metal collars 31 fixed at a plurality of places on both side surfaces of intermediate plate 3 to securely fix binding bar 2. In intermediate plate 3 of FIG. 20, metal collars 31 are fixed at three places, an upper and lower parts and a central part on one side. The number of metal collars 31 fixed to intermediate plate 3 is not specified, but such structure described above can fix intermediate plate 3 to the top and bottom and the middle so that binding bar 2 can be securely fixed.

Metal collars 31 are fixed while projecting from the side surface of intermediate plate 3 and have a flat tip. Further, each metal collar has female screw hole 31a in the central part of the metal collar. Set screw 14A, which is fixture 14 penetrating binding bar 2, is screwed into female screw hole 31a to connect binding bar 2 to intermediate plate 3.

### (Intermediate Plate Fixing Part 27)

Binding bar 2 is provided with intermediate plate fixing part 27 for fixing to metal collar 31 of intermediate plate 3 in the middle of binding bar 2 in the longitudinal direction. Here, as illustrated in FIG. 2, the direction of fixtures 14 for fixing intermediate plate 3 and binding bar 2 is set to be substantially perpendicular to the main surface of binding bar 2. By providing fixtures 14 such that axial force acts in a direction perpendicular to the extending direction of binding bar 2 in this way, a load applied to binding bar 2 can be reduced.

### (Fastening Member-Side Second Fixing Part 28)

Further, a plurality of fixing structures for fixing binding bar 2 to intermediate plate 3 can be provided. For example, fastening member-side second fixing part 28 may be provided in the middle of first bent piece 21. Binding bar 2 illustrated in FIG. 2 forms a first bent piece screw hole protruding from the center of first bent piece 21 as fastening member-side second fixing part 28. In this way, by providing fastening member-side second fixing part 28 at a part intersecting intermediate plate fixing part 27, binding bar 2 and intermediate plate 3 can be fixed at the positions where they intersect each other, thereby a stronger fixing structure in the different direction is achieved. Further, on the upper surface of intermediate plate 3, a bracket-side second screw hole is opened as bracket-side second fixing part 38 at a part facing the first bent piece screw hole. As a result, a screw can be screwed from the upper surface of battery stack 10 by inserting the screw into the first bent piece screw hole and the bracket-side second screw hole.

### (Fastening Member-Side Third Fixing Part 29)

Further, the fixing structure between binding bar 2 and intermediate plate 3 may be provided with three or more. For example, in the example of FIG. 2, a second bent piece screw hole is formed in the middle of second bent piece 22 as fastening member-side third fixing part 29. Similarly, intermediate plate 3 is also provided with a bracket-side third screw hole as a bracket-side third fixing part (not illustrated) at a position corresponding to fastening member-side third fixing part 29.

Further, in intermediate plate 3 illustrated in FIG. 20, the middle part is opened to reduce the amount of resin to be used. When the separator having a ventilation gap is arranged on both sides of the intermediate plate, the middle plate is formed in a shape that matches the shape of the separator, for example, unevenness of a cooling gap.

In the example of FIG. 2, the side surfaces of battery cell 1 are coated with separator 12 and joined to intermediate plate 3. In other words, separator 12 is interposed between battery cell 1 and intermediate plate 3. However, the separator may be omitted for a battery cell in contact with the intermediate plate. In this case, the above-mentioned cooling gap or the like may be formed on a surface of the intermediate plate such that a surface of the battery cell can be covered with the side surface of the intermediate plate.

The power supply device described above can be used as an automotive power source that supplies electric power to a motor used to cause an electric vehicle to travel. As an electric vehicle on which the power supply device is mounted, an electric vehicle such as a hybrid car or a plug-in hybrid car that travels by both an engine and a motor, or an electric car that travels only by a motor can be used, and the power supply device is used as a power source for these vehicles. Note that, in order to provide electric power that drives the vehicle, the vehicle can be equipped with a large-capacity, high-output power supply device can be constructed by connecting a large number of power supply devices described above in series or in parallel and additionally providing a necessary controlling circuit.

### (Power Supply Device for Hybrid Vehicle)

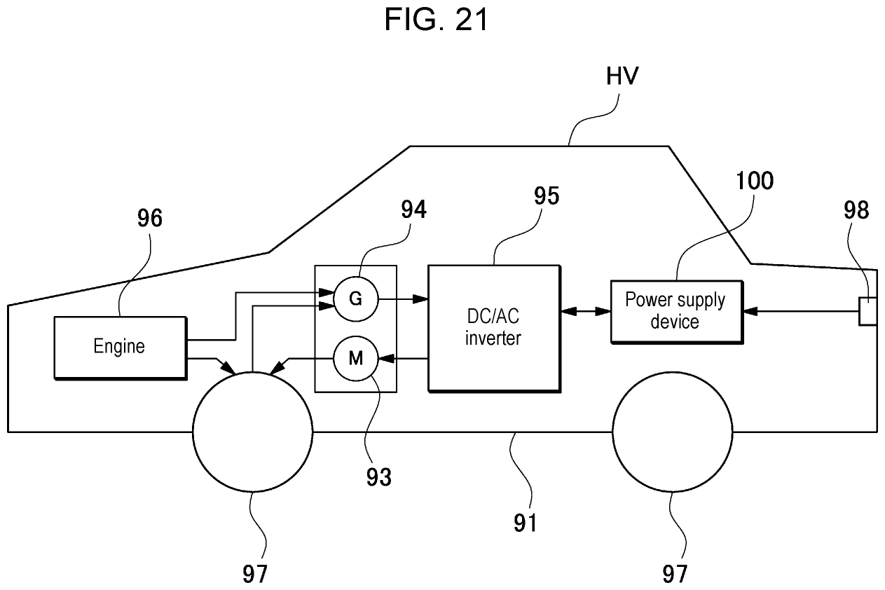

FIG. 21 illustrates an example of a power supply device mounted on a hybrid vehicle that travels by both an engine and a motor. Vehicle HV on which the power supply device illustrated in this drawing is mounted includes vehicle body 91, engine 96 and motor 93 for traveling that cause vehicle body 91 to travel, wheels 97 that are driven by engine 96 and motor 93 for traveling, power supply device 100 that supplies electric power to motor 93, and power generator 94 that charges batteries of power supply device 100. Power supply device 100 is connected to motor 93 and power generator 94 via DC/AC inverter 95. Vehicle HV travels by both motor 93 and engine 96 while charging and discharging the batteries of power supply device 100. Motor 93 is driven in a region where an engine efficiency is low, for example, during acceleration or low-speed traveling, and causes the vehicle to travel. Motor 93 is driven by electric power supplied from power supply device 100. Power generator 94 is driven by engine 96 or regenerative braking when the vehicle is braked to charge the batteries of power supply device 100. As illustrated in FIG. 21, vehicle HV may include charging plug 98 to charge power supply device 100. Connecting charging plug 98 to an external power source enables charging power supply device 100.

### (Power Supply Device for Electric Vehicle)

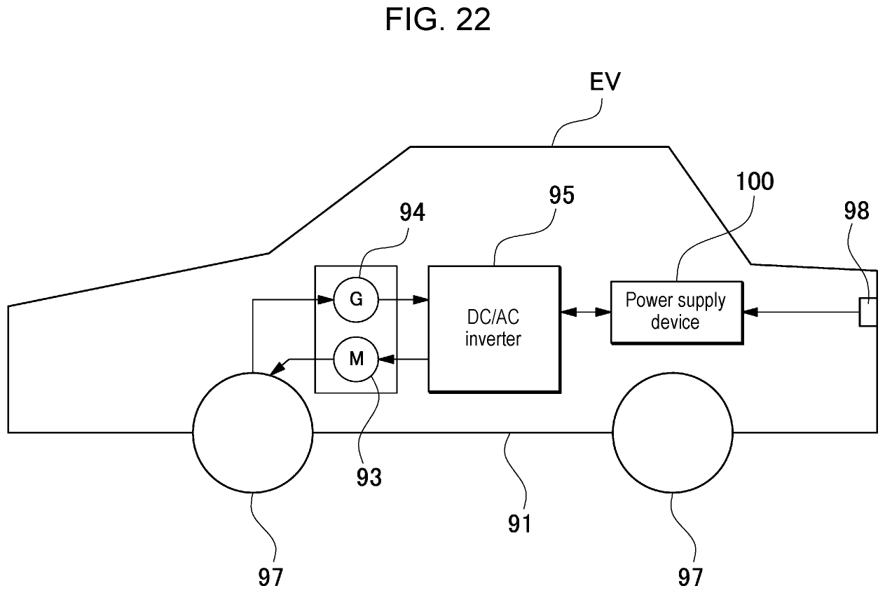

FIG. 22 illustrates an example of a power supply device mounted on an electric vehicle that travels only by a motor. Vehicle EV on which the power supply device illustrated in this figure is mounted includes vehicle body 91, travel motor 93 that causes vehicle body 91 to travel, wheels 97 that are driven by motor 93, power supply device 100 that supplies electric power to motor 93, and power generator 94 that charges batteries of power supply device 100. Power supply device 100 is connected to motor 93 and power generator 94 via DC/AC inverter 95. Motor 93 is driven by electric power supplied from power supply device 100. Power generator 94 is driven by energy at the time of regenerative braking of vehicle EV to charge the batteries of power supply device 100. Furthermore, vehicle EV includes charging plug 98, and connecting charging plug 98 to an external power source enables charging power supply device 100.

### (Power Supply Device for Power Storage Device)

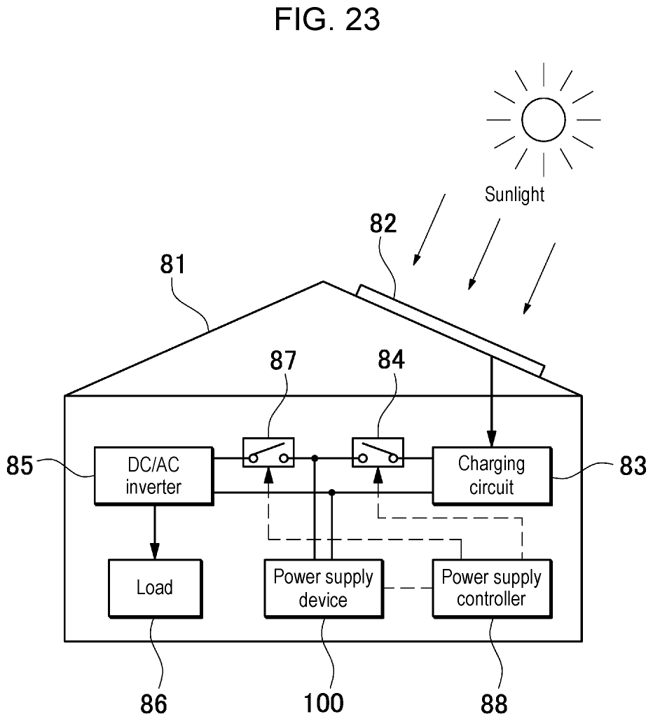

Further, the application of the power supply device of the present invention is not limited to a power supply for a motor that drives a vehicle. The power supply device according to the exemplary embodiment can also be used as a power source for a power storage device that stores electricity by charging a battery with electric power generated by solar power generation, wind power generation, or the like. FIG. 23 illustrates a power storage device that stores electricity by charging batteries of power supply device 100 with solar battery 82.

The power storage device illustrated in FIG. 23 charges the batteries of power supply device 100 with electric power generated by solar battery 82 that is disposed, for example, on a roof or a rooftop of building 81 such as a house or a factory. The power storage device charges the batteries of power supply device 100 through charging circuit 83 with solar battery 82 serving as a charging power source, and then supplies electric power to load 86 via DC/AC inverter 85. Thus, the power storage device has a charge mode and a discharge mode. In the power storage device illustrated in the drawing, DC/AC inverter 85 and charging circuit 83 are connected to power supply device 100 via discharging switch 87 and charging switch 84, respectively. Discharging switch 87 and charging switch 84 are turned on and off by power supply controller 88 of the power storage device. In the charge mode, power supply controller 88 turns on charging switch 84 and turns off discharging switch 87 to allow charging from charging circuit 83 to power supply device 100. When charging is completed and the batteries are fully charged or when a capacity of the batteries is charged at a predetermined value or higher, power supply controller 88 turns off charging switch 84 and turns on discharging switch 87 to switch to the discharge mode and permits power supply device 100 to discharge electricity into load 86. Further, when needed, power supply controller 88 can supply electric power to load 86 and charge power supply device 100 simultaneously by turning on charging switch 84 and turning on discharging switch 87.

Although not illustrated, the power supply device can also be used as a power source of a power storage device that stores electricity by charging a battery using midnight electric power at night. The power supply device charged by midnight power can be charged with midnight electric power, which is surplus power at power plants, so as to output electric power during the daytime when the electric power load is high, and to restrict peak power consumption at a low level in the daytime. Further, the power supply device can also be used as a power source that is charged with both output power of a solar battery and the midnight electric power. This power supply device can efficiently store electricity using both electric power generated by the solar battery and the midnight electric power effectively in consideration of weather and electric power consumption.

The power storage device described above can be suitably used for the following applications: a backup power supply device mountable on a rack of a computer server; a backup power supply device used for radio base stations of cellular phones; a power source for power storage used at home or in a factory; a power storage device combined with a solar battery, such as a power source for street lights; and a backup power source for traffic lights or traffic displays for roads.

### INDUSTRIAL APPLICABILITY

The power supply device, and electric vehicle and power storage device equipped with this power supply device, according to the present invention, are suitably used as a large current power supply used for a power supply of a motor for driving an electric vehicle such as a hybrid vehicle, a fuel cell vehicle, an electric vehicle, or an electric motorcycle. Examples of the power supply device include a power supply device for a plug-in hybrid electric vehicle and a hybrid electric vehicle capable of switching a traveling mode between an EV traveling mode and an HEV traveling mode, and an electric vehicle. Furthermore, the power supply device can also be appropriately used for the following applications: a backup power supply device mountable on a rack of a computer server; a backup power supply device used for radio base stations of cellular phones; a power source for power storage used at home or in a factory; a power storage device combined with a solar battery, such as a power source for street lights; and a backup power source for traffic lights.

### REFERENCE MARKS IN THE DRAWINGS

100: power supply device
1: battery cell
2: binding bar
3: intermediate plate
4: end plate
5: truss member
6, 6X, 6Y: arch member
9: insulating material
9a: opening region
10: battery stack
12: separator
13: bus bar
14: fixture
14A: set screw
21: first bent piece
22: second bent piece
23: third bent piece
24: fourth bent piece
25: fastening main surface
25a: opening
27: Intermediate plate fixing part
28: fastening member-side second fixing part
29: fastening member-side third fixing part
31: metal collar
31a: female screw hole
38: bracket-side second fixing part
40: fixing piece region
41: fixing piece
42: bending line
43: cutting line
44: slit
45: opening window
49: set screw
51: metal sheet
51A: flange
52: metal pipe
53: metal rod
55: lower string
56: upper string
57, 57A, 57B: inclined string
57X: main inclined string
57Y: sub-inclined string
58: vertical string
70: base plate
71: bracket
72: base plate connector
73: rising part
74: fixing part
75: female screw hole
76: nut
77: insertion hole
79: fixing screw
81: building
82: solar battery
83: charging circuit
84: charging switch
85: DC/AC inverter
86: load
87: discharging switch
88: power supply controller
91: vehicle body
93: motor
94: power generator
95: DC/AC inverter
96: engine
97: wheel
98: charging plug
HV, EV: vehicle

1. A power supply device comprising:
a battery stack including a plurality of prismatic battery cells stacked together;
a pair of end plates, each of the pair of the end plates being disposed at a corresponding one of ends of the battery stack, the ends being ends in a stacked direction of the battery stack; and
a binding bar coupled to the pair of the end plates, wherein
the binding bar is a metal sheet,
the binding bar includes a fixing piece for fixing a bracket to a base plate, the fixing pieces being integrated with the binding bar and protruding from a surface of the biding bar,
the binding bar defines a middle part of the binding bar in a longitudinal direction and a width direction as a fixing piece region constituting a fixing piece, a straight part extending in the longitudinal direction along a part of an outer peripheral edge of the fixing piece region as a bending line, and a region excluding the bending line on the outer peripheral edge of the fixing piece region as a cutting line, the cutting line being cut, the bending line being bent at the bending line, and the binding bar further defines the fixing piece region as an opening window where the fixing piece region protrude outward as the fixing piece, and
the bracket includes:
a fixing part fixed to the fixing piece;
a rising part provided with the fixing part at a distal end; and
a base plate connector provided at a lower end of the rising part, the fixing piece being fixed to the fixing part of the bracket, the binding bar being fixed to the base plate via the bracket.

2. The power supply device according to claim 1, further comprising a set screw penetrating the fixing piece and fixing the fixing piece to a fixing part of the bracket, wherein
the fixing piece includes a slit extending in the longitudinal direction of the binding bar,
the set screw is inserted into the slit to fix
the fixing piece and the fixing part of the bracket together.

3. The power supply device according to claim 2, wherein the binding bar includes the fixing piece including a plurality of slits each being the slit, the plurality of slits being disposed apart from each other in the longitudinal direction.

4. The power supply device according to claim 2, wherein
the binding bar includes a plurality of fixing pieces each being the fixing piece, the plurality of fixing pieces being disposed apart from each other in the longitudinal direction, and
each of the fixing pieces includes the slit.

5. The power supply device according to claim 1, wherein
each of a plurality of binding bars each disposed on a corresponding one of both sides of the battery stack includes the plurality of the fixing pieces, the biding bars each being the biding bar, and
the fixing piece of the each of the plurality of the binding bars each disposed on the corresponding one of both sides of the battery stack, the fixing piece being disposed at an asymmetric position from the fixing piece of other binding bar.

6. The power supply device according to claim 1, wherein the end plates are fixed to the base plate.

7. The power supply device according to claim 1, wherein the bending line is a straight line part of a lower edge of the fixing piece region.

8. The power supply device according to claim 1, wherein a truss member or an arch member includes an elongated bar is fixed on a surface of each of the plurality of binding bars each being the biding bar.

9. The power supply device according to claim 8, wherein the truss member or the arch member is coupled to each of the plurality of the fixing piece.

10. The power supply device according to claim 1, wherein
an intermediate plate is stacked in a middle of the battery stack, and
the intermediate plate is fixed to the binding bar.

11. An electric vehicle equipped with the power supply device according to claim 1, the electric vehicle comprising:
the power supply device;
a motor for traveling that receives electric power from the power supply device;
a vehicle body equipped with the power supply device and the motor; and
a wheel that is driven by the motor to cause the vehicle body to travel.

12. A power storage device equipped with the power supply device according to claim 1, the power storage device comprising:
the power storage device; and
a power supply controller controlling charging and discharging to the power supply device, wherein the power supply controller enables a battery cell among the plurality of prismatic battery cells to be charged with electric power from an outside and controls charging to the battery cells.
